(19) United States
(12) Patent Application Publication
(10) Pub. No.: US 2017/0239664 A1
(43) Pub. Date: Aug. 24, 2017

(54) TEST STRIP HOLDING DEVICE FOR LIQUID ANALYSIS

(71) Applicant: Flora Bioscience, Inc., Sunnyvale, CA (US)

(72) Inventors: John Paul Alderete, Sunnyvale, CA (US); Robert Francis Eisele, Carlsbad, CA (US)

(73) Assignee: Flora Bioscience, Inc., Sunnyvale, CA (US)

(21) Appl. No.: 15/051,490

(22) Filed: Feb. 23, 2016

(51) Int. Cl. B01L 9/00; G01N 21/78

(52) U.S. Cl. CPC B01L 9/52; G01N 21/78; B01L 2200/025; B01L 2300/12; B01L 2300/0858; B01L 2300/123; B01L 2200/026; G01N 2021/7796

(57) ABSTRACT

A test strip holder may include an upper body, a lower body, and a mating portion. The upper body may include a first recess. The lower body may include a second recess. The mating portion may fixedly mate the upper body and the lower body. The first recess and the second recess form an internal volume when the upper body and lower body are mated.

### BACKGROUND

Test strips may be used to determine the presence or absence of a target in a test fluid. To perform a test, a portion of a test strip may be submerged into a test fluid to expose the test strip to the test fluid. The test strip may generate an indication of the presence or absence of the target in response to exposure to the test fluid. The indication may inform a user of the test strip of the presence or absence of the target.

### SUMMARY

In one aspect, a test strip holder in accordance with one or more embodiments of the invention may include an upper body, a lower body, and a mating portion. The upper body may include a first recess. The lower body may include a second recess. The mating portion may fixedly mate the upper body and the lower body. The first recess and the second recess form an internal volume when the upper body and lower body are mated.

In one aspect, a test strip holder in accordance with one or more embodiments of the invention may include an upper body, a lower body, and a mating portion. The upper body may include a first recess and a first plurality of pressure points that directly contact a first surface of a test strip. The lower body may include a second recess; a second plurality of pressure points that directly contacts a second surface of the test strip; an interference feature, disposed on at least one side wall of the second recess, that pinches a width of the test strip; and a depth limiter, disposed on a side of the lower body opposite the second recess, including a portion that protrudes away from the lower body. The mating portion may fixedly mates the upper body and the lower body. The first recess and the second recess form an internal volume when the upper body and lower body are mated.

### BRIEF DESCRIPTION OF DRAWINGS

Certain embodiments of the invention will be described with reference to the accompanying drawings. However, the accompanying drawings illustrate only certain aspects or implementations of the invention by way of example and are not meant to limit the scope of the claims.

FIG. 1 shows an exploded isometric view of a test strip holder in accordance with one or more embodiments of the invention.

FIG. 2 shows an isometric view of a test strip in accordance with one or more embodiments of the invention.

FIG. 3A shows an isometric view of an upper body of a test strip holder in accordance with one or more embodiments of the invention.

FIG. 3B shows a bottom view of an upper body of a test strip holder in accordance with one or more embodiments of the invention.

FIG. 3C shows a side view of an upper body of a test strip holder in accordance with one or more embodiments of the invention.

FIG. 4A shows an isometric view of a top of a lower body of a test strip holder in accordance with one or more embodiments of the invention.

FIG. 4B shows an isometric view of a bottom of a lower body of a test strip holder in accordance with one or more embodiments of the invention.

FIG. 4C shows a diagram of a test strip holder and a test tube in accordance with one or more embodiments of the invention.

FIG. 5 shows an isometric view of a test strip holder near a first end of the test strip holder in accordance with one or more embodiments of the invention.

FIG. 6 shows an isometric cut view of a test strip holder near a first end of the test strip holder in accordance with one or more embodiments of the invention.

### DETAILED DESCRIPTION

Specific embodiments will now be described with reference to the accompanying figures. In the following description, numerous details are set forth as examples of the invention. It will be understood by those skilled in the art that one or more embodiments of the present invention may be practiced without these specific details and that numerous variations or modifications may be possible without departing from the scope of the invention. Certain details known to those of ordinary skill in the art are omitted to avoid obscuring the description.

In general, embodiments of the invention relate to a test strip holding device for liquid analysis. The liquid may be, for example, mucous, blood, skin, or any other bodily tissue and/or fluid. The liquid may include a detectable target such as, for example, protein or DNA, that is detectable by a test strip disposed within the test strip holding device. Detection of a target within the liquid may be used to diagnose a disease or condition.

The test strip holding device may include an internal volume for holding the test strip. The internal volume may include a number of pressure points and interference points, disposed along the length of the internal volume, for securing the test strip within the test strip holding device.

The pressure points may be distributed along the length of the internal volume. Pressure points may be distributed on a top and bottom surface of the inner volume. In one or more embodiments of the invention, the pressure points distributed on the top and bottom surface of the inner volume may be offset from other pressure points along the length of the inner volume. Offsetting the pressure points may prevent pinching of a test strip disposed within the inner volume across a thickness of the test strip.

The interference points may be distributed along the length of the internal volume. The interference points may be distributed on sidewalls of the inner volume. In one or more embodiments of the invention, the interference points distributed on the side walls may be distributed in pairs along the length of the inner volume. Pairing the interference points may generate a pinching of a test strip disposed within the inner volume across a width of the test strip. Generating a pinching across a width of the test strip, as opposed to a thickness of the test strip, may secure the test strip within the test strip holding while enabling fluid wicking along the length of a test strip disposed in the test strip holder.

The internal volume may include a fluid reception opening disposed at a first end of the length of the internal volume. The fluid reception opening may expose a portion of a test strip disposed within the test strip holder to the environment surrounding the test strip holder and thereby enable the test strip to interact with fluids proximate the test strip holder.

The internal volume may include one or more side flow paths proximate the fluid reception portion. The side flow paths may be a recessed portion that enables fluids that enter the fluid reception opening to flow along a side wall of a test strip disposed within the internal volume of the test strip holder. Flowing fluids along a side wall of the test strip may enable a test strip disposed within the internal volume to absorb fluids that flow into the fluid reception portion that would otherwise be prevented from being absorbed by the test strip by a cover layer disposed on one or more surfaces of the test strip.

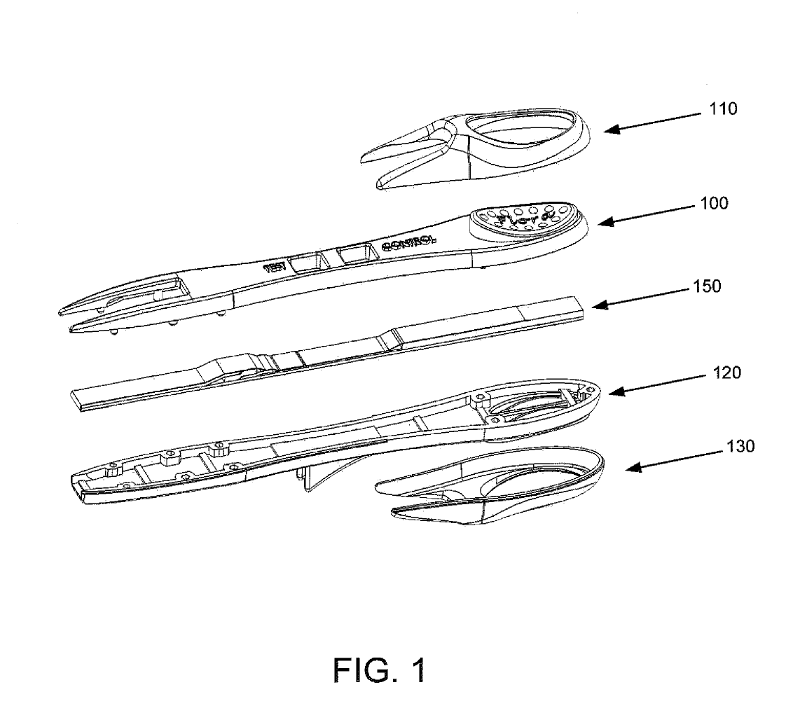

FIG. 1 shows an exploded perspective view of a test strip holder and a test strip (150) in accordance with one or more embodiments of the invention. The test strip holder may include an upper body (100), upper cap (110), lower body (120), and lower cap (130). The test strip (150) and each of the aforementioned components of the test strip holder are described below.

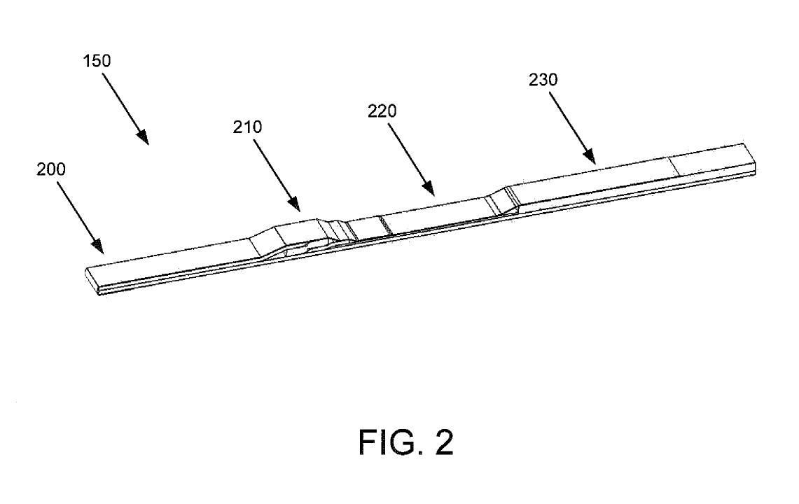

FIG. 2 shows an example of a test strip (150) in accordance with one or more embodiments of the invention. The test strip (150) may be a fluid wicking strip that indicates the presence or absence of a target when the test strip is exposed to a fluid. The test strip (150) may be configured to receive a test fluid at a first end (200) of the length of the test strip (150). When the test strip receives the test fluid, the test fluid may wick along the test strip. The wicking of the fluid may be caused by, for example, capillary action.

The test strip (150) may include an analytical region (210) that reacts to the presence or absence of a target within the test fluid when the test fluid is wicked into the analytical region (210). The reaction may add a detectable product to the test fluid. In one or more embodiments of the invention, the detectable product may be an antibody bound to an indicator.

The test strip (150) may include an indicator region (220). The indicator region (220) may bind the detectable product to the location of the indicator region (220). Binding the detectable product to the indicator region (220) may cause the quantity of the detectable product in the indicator region (220) to increase. Increasing the detectable product in the indicator region (220) may cause the light reflectivity of the indicator region (220) to change and thereby indicate to a user of the test strip (150) the presence or absence of the target. The change in light reflectivity of the indicator region (220) may be, for example, a change in the color of the region.

In one or more embodiments of the invention, the indicator region (220) may include a verification region that provides a visual indication of the operation of the test strip (150). The visual indication may be, for example, a change in the light reflectivity of the verification region. A change in the light reflectivity of the verification may indicate to a user of the test strip (150) that the test strip (150) is functioning and thereby assure a user of the test strip (150) that the test strip (150) is functioning as desired.

The test strip (150) may include an absorbent pad (230). The absorbent pad (230) may absorb test fluid that wicks from the first end (200) of the test strip (150) along the length of the test strip (150). By absorbing the test fluid, the absorbent pad (230) may enable more test fluid to wick along the length of the test strip (150), before the test strip (150) becomes saturated and no longer wicks fluid, when compared to a test strip that does not include an absorbent pad.

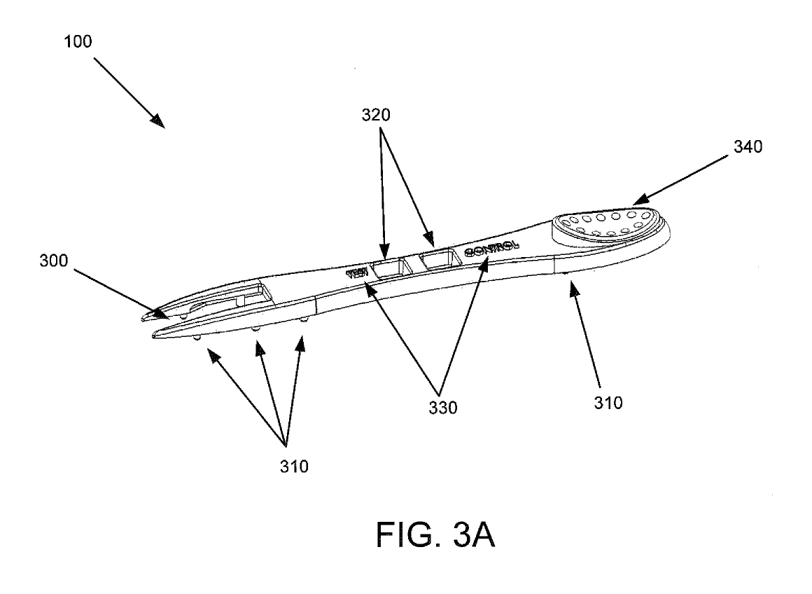

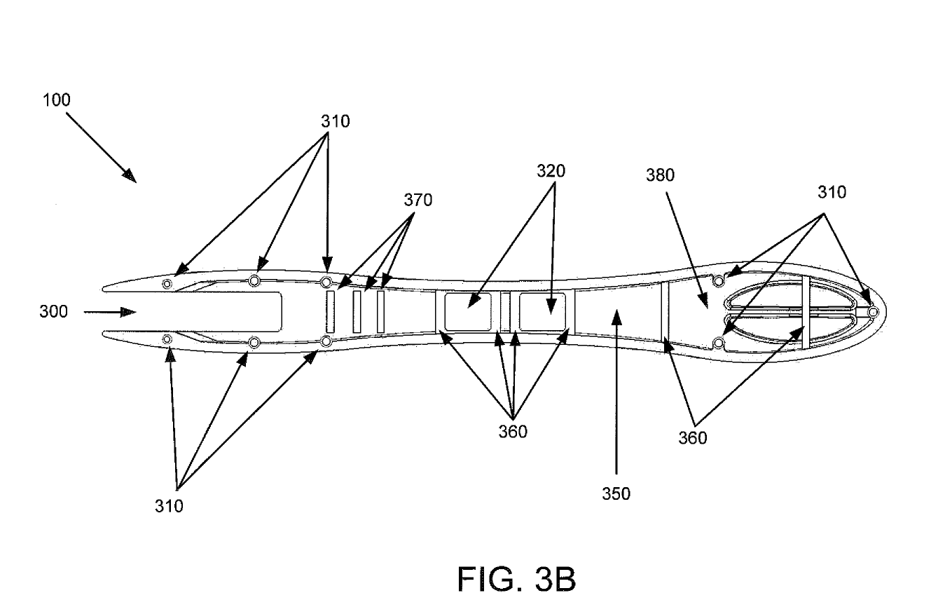

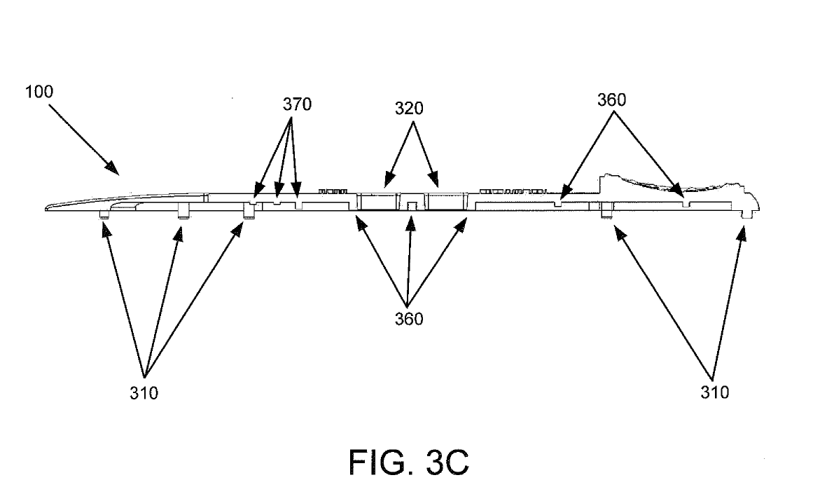

Returning to FIG. 1, the test strip holder may include an upper body (100). An example of an isometric view of the upper body (100) in accordance with one or more embodiments of the invention is shown in FIG. 3A. The upper body (100) may be a structural component. In one or more embodiments of the invention, the upper body (100) may be formed by plastic injection molding. The upper body (100) may be formed of a thermoplastic, thermoset, or an elastomer material. For example, the upper body (100) may be an epoxy, nylon, polyethylene, polystyrene, polycarbonate, or a thermoplastic.

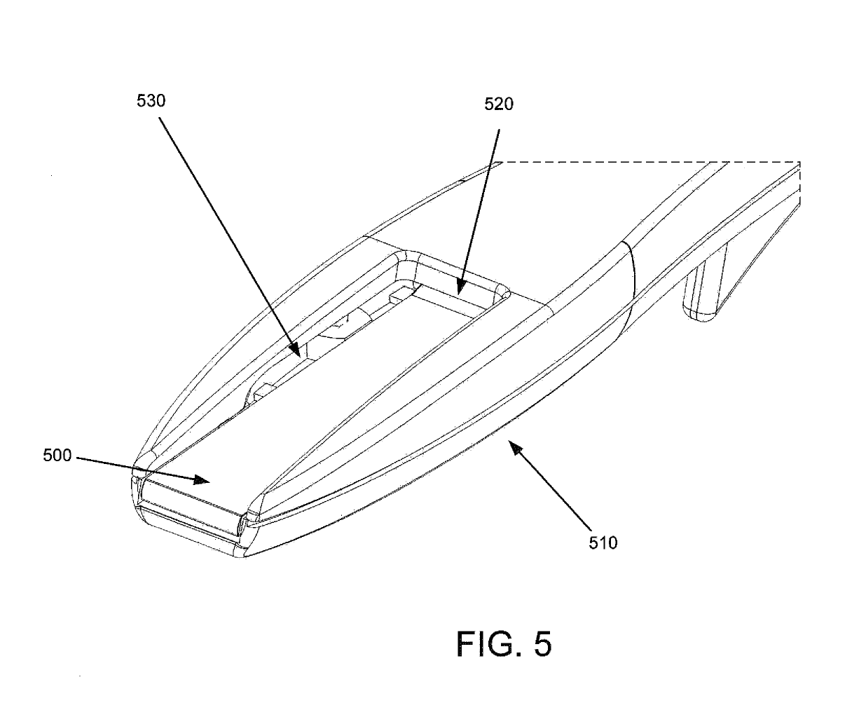

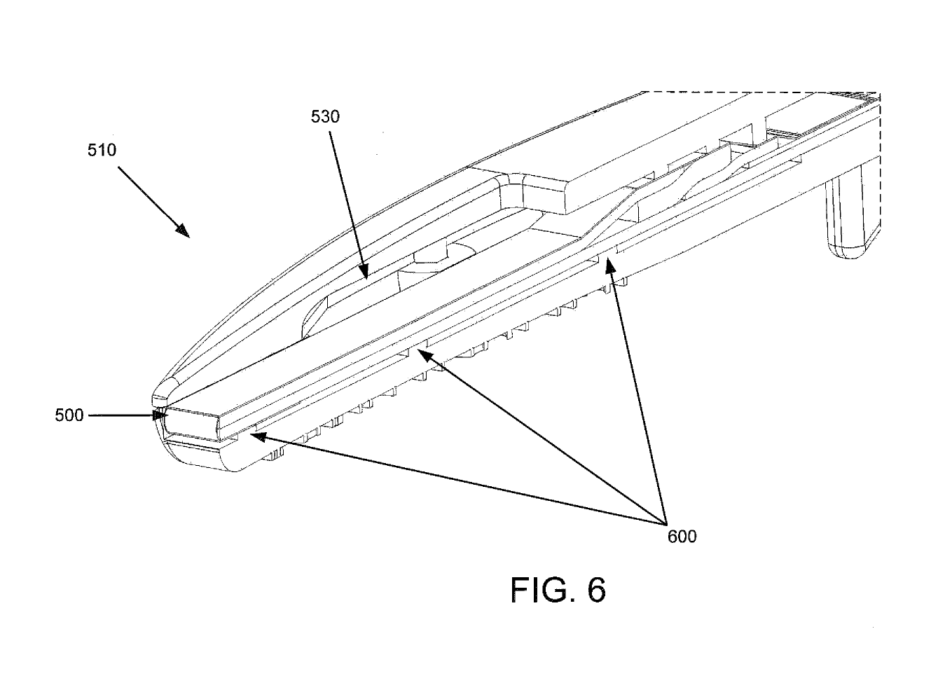

The upper body (100) may include a fluid reception opening (300) at a first end of the length of the upper body (100). The fluid reception opening (300) may enable a fluid, proximate to the fluid reception opening (300) to interact with a test strip disposed within the test strip holder. The fluid reception opening (300) will be described in greater detail with respect to FIGS. 5-6.

The upper body (100) may include a number of mating portions (310) disposed along the length of the upper body (100). The mating portions (310) may be structural components configured to mate with complimentary components of the lower body (120, FIG. 1). The mating portions (310) may be, for example, pins. In one or more embodiments of the invention, the pins may have a cross section that includes an interference portion configured to lock the pins with the complimentary components of the lower body (120, FIG. 1) and thereby fixedly attach the upper body (100) to the lower body (120, FIG. 1). The mating portions (310) are further described with respect to FIG. 3B.

FIG. 3B shows a bottom view of the upper body (100) in accordance with one or more embodiments of the invention. As seen from FIG. 3B, mating portions (310) may be distributed along the length of the upper body (100) and across the width of the upper body (100). In one or more embodiments of the invention, mating portions (310) may be distributed proximate the first end and the second end of the length of the upper body (100) and may be absent near the center of the length of the upper body (100).

Returning to FIG. 3A, the upper body (100) may include windows (320). The windows (320) may enable a portion of a test strip, disposed within the test strip holder, to be visually inspected by a user of the test strip holder. The windows (320) may be, for example, orifices or ports that expose the portions of the test strip proximate to the windows (320). In one or more embodiments of the invention, the windows (320) may include transparent or translucent covers (not shown) that enable a user of the test strip holder to view the portion of the test strip while preventing the environment surrounding the test strip holder to interact with the test strip by way of the windows (320). The windows (320) of the upper body (100) may be disposed along the length of the upper body (100) at locations corresponding to an indicator region of a test strip.

The upper body (100) may include indicator features (330) disposed proximate to the windows (320). The indicator features (330) may indicate the function of the portions of the test strip exposed to a user by the windows (320). For example, the test strip may include a test and a control region within the indicator region (220, FIG. 2). The indicator features (330) may indicate the function of the test and control region of the test strip.

In one or more embodiments of the invention, the indicator features (330) may be raised lettering that is readable by a user of the test strip holder. In one or more embodiments of the invention, the indicator features (330) may be symbols that are readable by a user of the test strip holder.

The upper body (100) may include a holding portion (340) disposed at a second end of the length of the upper body (100). The holding portion (340) may be configured to enable a user of the test strip holder to grip the test strip holder. The holding portion (340) may include a recessed area that is complimentary to an appendage of a user. A number of raised features may be present in the holding portion (340) that create an interference between the holding portion (340) and the fingers of a user, thereby reducing the propensity for the holding portion (340) to slip from the fingers of the user.

Turning to FIG. 3B, the upper body (100) may include a recessed portion (350) disposed along the length and width of the upper body (100). The recessed portion (350) may have a shape and size that is similar to a complementary recessed portion of the lower body (120, FIG. 2) and thereby form a hollow internal volume when the upper body (100) and lower body (120, FIG. 2) are mated together. As discussed above, the internal volume may be configured to receive a test strip.

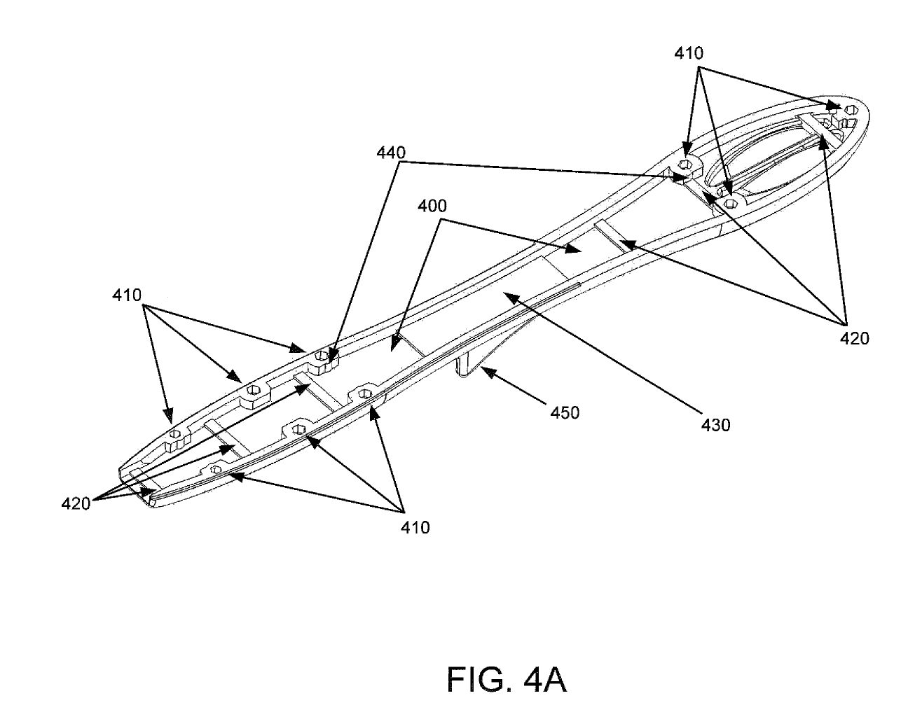

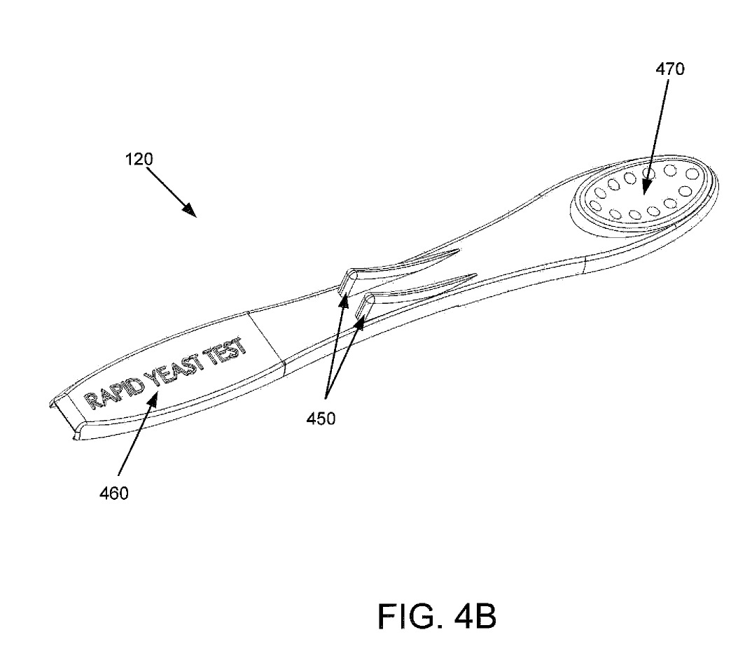

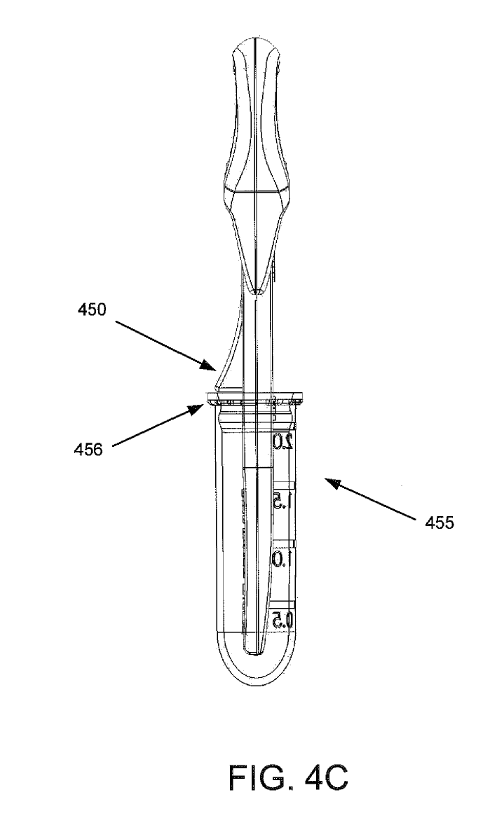

The upper body (100) may include a number of pressure points (360) disposed along the length of the upper body (100). The pressure points (360) may be raised features that apply pressure to a test strip disposed within the internal volume of the test strip holder. As will be discussed with respect to FIG. 4A, the lower body (120, FIG. 2) may also include pressure points. The pressure points of the upper body (100) and lower body (120, FIG. 2) may be distributed along the length of each component so that upper body (100) pressure points offset from lower body (120, FIG. 2) pressure points. Offsetting the upper body and lower body pressure points may prevent pinching of a test strip disposed within the test strip holder that would prevent wicking of a test fluid along the test strip and thereby render the test strip inoperable.

The upper body (100) may include a number of compression points (370) disposed along the length of the upper body (100). The compression points (370) may be raised features that compress critical interfaces of a test strip disposed within the test strip holder. The compression points (370) may be disposed at locations proximate to the critical interface of the test strip. For example, the test strip may include a number of critical interfaces in an analytical region (210, FIG. 2) of the test strip. The size and location of the compression points (370) may be configured to compress critical interfaces to ensure wicking of a test fluid along the test strip.

The mating portions (310), pressure points (360), and compression points (370) are further described with respect to FIG. 3C. FIG. 3C shows a cross sectional view of the upper body (100) in accordance with one or more embodiments of the invention. As seen from FIG. 3C, the relative size and height of the mating portions (310) may vary along the length of the upper body (100).

Also, as seen from FIG. 3C, the height of the pressure points (360) may also vary along the length of the upper body (100). For example, the height of the pressure points (360) disposed near the windows (320) may be greater than the height of the pressure points (360) near the first or second end of the upper body (300). The difference in height of the pressure points (360) may apply different pressures to the test strip. The application of different pressures along the length of the test strip may ensure that test fluid wicks along the test strip and that the test strip is secured within the internal volume of the test strip holder.

The height of the compression points (370) may, like the pressure points (360), vary along the length of the upper body (100). The height of each compression point may be configured to compress one or more critical interfaces of the test strip.

Returning to FIG. 3A, the recessed portion (350) of the upper body (100) may include a larger recess (380) disposed at the second end of the upper body (100). The larger recess (380) at the second end may increase the volume of the internal volume of the test strip holder at a location that is proximate to the absorbent pad (230, FIG. 2) of a test strip disposed within the test strip holder. The larger recess (380) may promote wicking of test fluid along the length of the test strip by ensuring that gasses are free to escape out of the test strip near the larger recess (380).

Returning to FIG. 1, the test strip holder may include an upper cap (110). The upper cap (110) may be a structural component disposed on the upper body (100). The upper cap (100) may be formed by a plastic injection molding process and may be formed from a malleable material. The malleable material may be, for example, polydimethylsiloxane, natural rubber, or a latex based material. The upper cap (110) may improve the ability of the user of the test strip holder to grip and/or manipulate the test strip holder. In one or more embodiments of the invention, the upper cap (110) may be plastic injection molded directly onto the upper body (100) and thereby form a unitary structure.

The test strip holder may include a lower body (120). FIG. 4A shows an isometric view of a lower body (120) in accordance with one or more embodiments of the invention. The lower body (120) may be configured to mate with the upper body (100, FIG. 1) to form an internal volume that may house a test strip. The lower body (120) may be formed by plastic injection molding and may be formed of the same material of the upper body (100).

The lower body (120) may include a recessed portion (400) having a shape and size similar to that of the recessed portion (350, FIG. 3B) of the upper body. The recessed portions of the upper and lower body may form the internal volume of the test strip holder when the upper body and lower body are mated together.

The lower body (120) may include a number of complementary mating portions (410). The complementary mating portions (410) may be recesses or other features configured to mate with the mating portions of the upper body. The complementary mating portions (410) may be disposed at locations along the length and width of the lower body (120) that are complimentary to the locations of the mating portions of the upper body. In one or more embodiments of the invention, the complementary mating portions (410) may have a cross section that interferes with a cross section of the mating portions of the upper body. The interference between the mating portions may fixedly secure the upper body and lower body together when mated together.

The lower body (120) may include a number of pressure points (420) disposed along the length of the lower body (120). The pressure points (420) may be structural features, such as raised points, that apply pressure to a test strip disposed within the test strip holder. The pressure applied by the pressure points (420) to the test strip may ensure that the test strip is secured within the test strip holder.

The lower body (120) may include a window seat (430). The window seat (430) may be a raised area of the lower body (120) having a location proximate the windows (320, FIG. 3A) of the upper body when the lower body and upper body are mated. The window seat (430) of the lower body and pressure points of the upper body near the windows of the upper body may ensure that the indicator region (220) of the test strip is secured and lays flat. By securing and forcing the indicator region (220) of the test strip to lay flat, optical distortions caused by a curling or raising of the indicator region (220) of the test strip may be prevented and thereby enable a user of the test strip holder to read the indicator region (220).

The lower body (120) may include a number of interference features (440) disposed on the sidewalls of the recessed portion (400) of the lower body. The interference features (440) may be raised portions of the sidewalls. The interference features (440) may be disposed along the length of the lower body (120) in pairs on opposite side walls. The pairs of interference features (440) may reduce the width of the recessed region (400) near the pairs to less than the width of the test strip and thereby pinch a test strip disposed within the test strip holder near each pair of interference features. Pinching by the pairs of interference features (440) may fixedly secure the test strip within the test strip holder by applying compressive force to the test strip while ensuring that the compressive force does not prevent a test fluid from wicking along the length of the test strip.

The lower body (120) may include a depth limiter (450). The depth limiter (450) may be a structural feature that may be used to control the depth of submersion of the test strip holder within a test fluid. Controlling the depth of submersion may prevent the test strip from touching the bottom of a vessel holding a test fluid and thereby prevent accumulated particulate material from the test fluid from interacting with the test strip. The depth limiter (450) may also prevent a test strip from unintentionally interacting with surfaces that may lead to contamination of the test strip. The depth limiter (450) may be, for example, a protruding portion that may rest on a lip of a container that holds a test fluid. The depth limiter (450) is further described with respect to FIG. 4B.

FIG. 4B shows a bottom isometric view of the lower body (120) in accordance with one or more embodiments of the invention. As seen from FIG. 4B, the depth limiter (450) may be one or more portions of the lower body (120) that protrude away from a length of the lower body (120). The depth limiter (450) may be located at a position along the length of the lower body (120) that is set based on a desired depth of submersion of the test strip holder within the test strip. For example, when the depth limiter (450) is positioned closer to the fluid reception opening (300, FIG. 3A) of the upper body, the submersion depth may be reduced and when the depth limiter (450) is positioned farther away from the fluid reception opening (300, FIG. 3A) of the upper body, the submersion depth may be increased. While the depth limiter (450) has been described as a protruding portion and shown as two thin protrusions, the depth limiter (450) may have other shapes without departing from the invention. For example, the depth limiter (450) may be a conical body of rotation about the length of the test strip holder, e.g., encircling the body of the test strip holder about the length of the test strip holder. The body of revolution may be a full 360° body of revolution or a partial body of revolution, e.g., 180°.

FIG. 4C shows a diagram of an example of a test strip holder disposed near a test tube (455) in accordance with one or more embodiments of the invention. More specifically, FIG. 4C shows a depth limiter (450) of a test strip holder controlling the submersion depth of the test strip holder. The depth limiter (450) may control the submersion depth of the test strip holder by resting on a lip (456) of the test tube (455) and thereby prevent the test strip holder from submerging to a greater depth due to gravity and/or other forces.

While the test strip holder has been illustrated as being submerged into a test tube (455) in FIG. 4C, one of ordinary skill in the art will appreciate that another fluid holding structure other than a test tube (455) may be used without departing from the invention.

Returning to FIG. 4B, the lower body (120) may include a test type indicator (460). The test type indicator (460) may indicate a type of test strip housed in the test strip holder. The test type indicator (460) may be a symbol, text, or other indicator.

The lower body (120) may include a holding portion (470) at a location corresponding to the location of the holding portion (340, FIG. 3A) of the upper body. The holding portion (470) of the lower body (120) may be configured to enable a user of the test strip holder to grip the test strip holder. The holding portion (470) may include a recessed area that is complimentary to an appendage of a user. A number of raised features may be present in the holding portion (470) that create an interference between the holding portion (470) and the flingers of a user, thereby reducing the propensity for the holding portion (470) to slip from the fingers of a user.

Returning to FIG. 1, the test strip holder may include a lower cap (130). The lower cap (130) may be a structural component disposed on the lower body (120). The lower cap (130) may formed by a plastic injection molding process and may be formed from a rubberized material. The lower cap (130) may improve the ability of the user of the test strip holder to grip and/or manipulate the test strip holder. In one or more embodiments of the invention, the lower cap (130) may be plastic injection molded directly onto the lower body (120) and thereby form a unitary structure.

Thus, the test strip holder shown in FIG. 1 may be used to hold a test strip. When used, a portion of the test strip holder may be submerged in a test fluid.

FIG. 5 shows an isometric view of a test strip (500) disposed within a test strip holder (510) in accordance with one or more embodiments of the invention. More specifically, FIG. 5 shows an isometric of the test strip holder (510) near a fluid reception opening (520). As seen from FIG. 5, the fluid reception opening (520) includes side flow paths (530) that enable test fluid to flow around the sides of the test strip (500) when the fluid reception opening (520) is submerged in a test fluid. By flowing around the sides of the test strip (500), the test fluid is able to interact with the side surfaces of the test strip (500).

In one or more embodiments of the invention, the test strip (500) may include a cover layer disposed on the top surface of the test strip that is exposed to an ambient environment surrounding the test strip holder. The cover layer may be a barrier layer that prevents contamination of the test strip (500) by way of the stop of the top surface of the test strip. For example, when a user of the test strip holder (510) picks it up, the user may inadvertently pick it up by the end including the fluid reception opening (520) and make direct contact with the test strip (500). The cover layer may prevent oils, debris, and/or other materials on the fingers of a user from contaminating the test strip.

Thus, the side flow paths (530) in combination with the cover layer of the test strip may prevent contamination of the test strip (500) while still enabling a test fluid to interact with the test strip (500) by way of the side flow paths (530). The side flow paths (530) may enable the test fluid to interact with the side surface of the test strip (500), be wicked into the test strip (500), and thereby enable the test strip (500) to \perform a test. The operation of the test strip holder (510) is further described with respect to FIG. 6.

FIG. 6 shows a cut view of the test strip holder (510) and the test strip (500) along the length of the test strip holder (510) of FIG. 5. As seen from FIG. 6, the test strip holder (510) includes a number of pressure points (600) that suspend the test strip off of the lower surface of the interior region. Suspending the test strip (500) may prevent the test strip (500) from being pinched in a way that would otherwise prevent fluid from flowing along the test strip (500). Suspending the test strip (500) may also enable fluid flow along the side surfaces of the test strip (500) by way of the side flow paths (530).

Thus, when the test strip holder (510) is submerged in a test fluid, test fluid may flow into the fluid reception opening of the test strip holder (510). The test fluid may flow along the side surface of the test strip (500) by way of the side flow paths (530) and be wicked into the test strip (500). The test fluid may wick along the length of the test strip (500) and generate an indication result which may be viewable by a user of the test strip holder through the windows (320, FIG. 3A) of the test strip holder (510).

One or more embodiments of the invention may enable one or more of the following: i) analysis of a fluid by a test strip while preventing contamination of the test strip, ii) securing of the test strip within a test strip holder by applying compressive force while preventing the test strip from being pinched, iii) providing a user of a test strip holder with a visual indication of both the operation of the test strip and the presence or absence of a target within a test fluid, and iv) providing a user of the test strip holder with an indication of the meaning of indicator regions of the test trip and an indication of a type of test strip housed in the test strip holder.

While the invention has been described above with respect to a limited number of embodiments, those skilled in the art, having the benefit of this disclosure, will appreciate that other embodiments can be devised which do not depart from the scope of the invention as disclosed herein. Accordingly, the scope of the invention should be limited only by the attached claims.

What is claimed is:

1. A test strip holder, comprising:
an upper body comprising a first recess;
a lower body comprising a second recess; and
a mating portion configured to fixedly mate the upper body and the lower body,
wherein the first recess and the second recess form an internal volume when the upper body and lower body are mated.

2. The test strip holder of claim 1, wherein the upper body further comprises:
a first plurality of pressure points configured to directly contact a first surface of a test strip.

3. The test strip holder of claim 2, wherein the lower body further comprises:
a second plurality of pressure points configured to directly contact a second surface of the test strip.

4. The test strip holder of claim 3, wherein each pressure point of the first plurality of pressure points is disposed at a different location along a length of the test strip holder than each pressure point of the second plurality of pressure points.

5. The test strip holder of claim 1, wherein the upper body further comprises:
a first compression point disposed at a first location along a length of the upper body that corresponds to a location of a critical interface of the test strip.

6. The test strip holder of claim 5, wherein the upper body further comprises:
a second compression point disposed at a second location along the length of the upper body.

7. The test strip holder of claim 6, wherein the first compression point extends into the first recess a first distance, wherein the second compression point extends into the first recess a second distance, wherein the first distance is larger than the second distance.

8. The test strip holder of claim 1, wherein the upper body further comprises:
a fluid recess opening configured to expose a top surface of the test strip to an environment surrounding the test strip holder.

9. The test strip holder of claim 8, wherein the fluid recess opening further comprises:
a side flow path configured to expose a side wall of the test strip to the environment surrounding the test strip holder.

10. The test strip holder of claim 9, wherein the test strip is disposed within the internal volume.

11. The test strip holder of claim 1, wherein the upper body further comprises:
a window configured to expose an indicator surface of the test strip to an environment surrounding the test strip holder.

12. The test strip holder of claim 1, wherein the lower body further comprises:
a depth limiter comprising a portion that protrudes away from the lower body.

13. The test strip holder of claim 12, wherein the depth limiter is disposed on a side of the lower body opposite the second recess.

14. The test strip holder of claim 1, wherein the upper body comprises at least one selected from a group consisting of an epoxy, nylon, polyethylene, polystyrene, polycarbonate, and thermoplastic.

15. The test strip holder of claim 1, wherein the upper body comprises polycarbonate.

16. The test strip holder of claim 1, wherein the lower body further comprises:
an interference feature, disposed on a side wall of the second recess, configured to pinch a width of the test strip.

17. The test strip holder of claim 16, wherein the interference feature comprises:
a first protrusion disposed on a first sidewall of the lower body; and
a second protrusion disposed on a second side wall of the lower body.

18. A test strip holder, comprising:
an upper body comprising:
a first recess;
a first plurality of pressure points that directly contact a first surface of a test strip;
a lower body comprising:
a second recess;
a second plurality of pressure points that directly contacts a second surface of the test strip;
an interference feature, disposed on at least one side wall of the second recess, that pinches a width of the test strip;
a depth limiter, disposed on a side of the lower body opposite the second recess, comprising a portion that protrudes away from the lower body; and
a mating portion that fixedly mates the upper body and the lower body,
wherein the first recess and the second recess form an internal volume when the upper body and lower body are mated.

19. The test strip holder of claim 18, wherein the upper body further comprises:
a window that exposes an indicator surface of the test strip to an environment surrounding the test strip holder.

20. The test strip holder of claim 18, wherein the test strip is disposed within the internal volume.

21. The test strip holder of claim 18, wherein the internal volume comprises:
a fluid reception opening at a first end of a length of the internal volume; and
a recess at a second end of the length of the internal volume.

22. The test strip holder of claim 21, wherein the recess has a volume that receives a gas from the test strip when the test strip is exposed to a test fluid.

23. The test strip holder of claim 22, wherein receiving the gas improves a flow rate of the test fluid through the test strip.

24. The test strip holder of claim 22, wherein the test strip is exposed to a fluid by the fluid reception opening.

25. The test strip holder of claim 18, wherein the upper body comprises a holding portion disposed on a side of the upper body opposite the internal volume.

26. The test strip holder of claim 18, wherein a first portion of the test strip holder comprising plastic and a second portion of the test strip holder comprising a malleable material.

27. The test strip holder of claim 26, wherein the first portion is a holding portion of the upper body.

28. The test strip holder of claim 27, wherein the second portion is a cap disposed adjacent to the holding portion.

29. The test strip holder of claim 26, wherein the malleable material is one selected from a group consisting of polydimethylsiloxane, natural rubber, and a latex based material.
